(19) United States
(12) Patent Application Publication
(10) Pub. No.: US 2016/0129582 A1
(43) Pub. Date: May 12, 2016

(54) Power-Tool Stand Device

(71) Applicant: Robert Bosch GmbH, Stuttgart (DE)

(72) Inventor: Andre Ullrich, Leinfelden-Echterdingen (DE)

(21) Appl. No.: 14/935,216

(22) Filed: Nov. 6, 2015

(30) Foreign Application Priority Data
Nov. 10, 2014 (DE) 10 2014 222 847.6

(51) Int. Cl. B25H 1/00; B23Q 3/154

(52) U.S. Cl. CPC B25H 1/0071; B23Q 3/1543

(57) ABSTRACT

A power-tool stand device, in particular a drill stand device, on which at least one insert tool can be arranged in a drivable manner for the purpose of performing work on a workpiece includes at least one base body having at least one switchable magnet unit at least for fixing the base body to a magnetizable object, and further having at least one energy supply unit. The energy supply unit is configured to supply energy at least to the magnet unit independently of an electricity supply network.

This application claims priority under 35 U.S.C. §119 to patent application no. DE 10 2014 222 847.6, filed on Nov. 10, 2014 in Germany, the disclosure of which is incorporated herein by reference in its entirety.

### BACKGROUND

A power-tool stand device, on which at least one insert tool can be arranged in a drivable manner for the purpose of performing work on a workpiece, is already known from EP 0 554 017 B 1. The power-tool stand device in this case comprises a base body, a switchable magnet unit for fixing the base body to a magnetizable object, and an energy supply unit.

### SUMMARY

The disclosure is based on a power-tool stand device, in particular a drill stand device, on which at least one insert tool can be arranged in a drivable manner for the purpose of performing work on a workpiece, having at least one base body, having at least one switchable magnet unit at least for fixing the base body to a magnetizable object, in particular to a metallic workpiece, and having at least one energy supply unit.

It is proposed that the energy supply unit be provided, at least, to supply energy at least to the magnet unit, independently of an electricity supply network. Preferably, the power-tool stand device is realized as a drill stand device. If the power-tool stand device is realized as a drill stand device, the insert tool can preferably be arranged on a tool receiver of a portable power tool that can be arranged in a detachable manner on the drill stand device. In an alternative design, the power-tool stand device is realized as a box column drill. Preferably, if the power-tool stand device is realized as a box column drill, the insert tool can be arranged on a tool receiver of the power-tool stand device. Preferably, the insert tool, which can be arranged on the power-tool stand device in a drivable manner for the purpose of performing work on a workpiece, is realized as a drill bit. It is also conceivable, however, for the insert tool to be of another design, considered appropriate by persons skilled in the art.

The base body preferably comprises at least one object bearing-contact face, in particular a workpiece bearing-contact face, by means of which the base body can be arranged on an object, in particular on a workpiece on which work is to be performed, in particular can be placed onto a workpiece. Preferably, when the base body has been arranged on the object, in particular on the workpiece, the object bearing-contact face, in particular the workpiece bearing-contact face, of the base body bears directly against an object surface, in particular the workpiece surface. The switchable magnet unit, in particular at least one magnet element of the magnet unit, is preferably arranged in proximity to the object surface, in particular of the workpiece surface. “Proximity” is to be understood here to mean, in particular, a region having a maximum distance from the object bearing-contact surface, in particular from the workpiece bearing-contact surface, that is less than 10 mm, preferably less than 1 mm, and particularly preferably less than 0.1 mm. Quite particularly preferably, the switchable magnet unit, in particular at least one magnet element of the magnet unit, bears directly against the object bearing-contact face, in particular the workpiece bearing-contact face, or constitutes the object bearing-contact face, in particular the workpiece bearing-contact face, of the base body. Preferably, the switchable magnet unit is arranged on the base body. Preferably, the base body is made of a magnetizable material. It is also conceivable, however, for the base body to be made, at least largely, of a non-magnetizable material, and to be made of a magnetizable material only in the region of the object bearing-contact face, in particular the workpiece bearing-contact face, or for the base body to be made entirely of a non-magnetizable material, and the switchable magnet unit to constitute the object bearing-contact face, in particular the workpiece bearing-contact face, of the base body, at least partially. Likewise conceivable are other designs of the base body and/or of the switchable magnet unit that are considered appropriate by persons skilled in the art, such as, for example, a design such that the magnet unit can be removed from the base body, a design such that the magnet unit is integral with the base body, the magnet unit is movably mounted on the base body, or the like.

A “switchable magnet unit” is to be understood here to mean, in particular, a magnet unit comprising at least one magnet element, the magnetic action of which can be changed by means of a switching operation such as, for example, polarity reversal of a magnetic field, removal of an action of a magnetic field, setting of a strength of a magnetic field, or the like. The switchable magnet unit may be realized as a switchable permanent-magnet unit and/or as a switchable electromagnet unit. Preferably, an action of a magnetic field of the switchable magnet unit can be removed as a result of a switching operation.

The energy supply unit is preferably provided, at least, to supply the magnet unit with electrical energy. “Provided” is to be understood to mean, in particular, specially designed and/or specially equipped. That an element and/or a unit is provided for a particular function, is to be understood to mean, in particular, that the element and/or the unit fulfill/fulfills and/or execute/executes this particular function in at least one application state and/or operating state. The term “independent of an electricity supply network” is intended here to define, in particular, a supply of energy, in particular electrical energy, to at least one element and/or at least one unit, the electrical energy being obtainable from an energy storage device that can provide energy, in particular stored energy, at least temporarily, independently of an electricity supply network. Preferably, the energy storage unit comprises at least one energy storage unit, in particular a rechargeable energy storage unit. The energy storage unit may be integrated into the base body, or may be realized so as to be removable from the base body. Preferably, the energy storage unit is realized as a battery unit that, in particular, comprises a multiplicity of rechargeable cells. Other designs and/or arrangements of the energy storage unit, considered appropriate by persons skilled in the art, are likewise conceivable.

The design according to the disclosure makes it possible, advantageously, to use the power-tool stand device in a variable manner, in particular to attach the base body to an object, in particular a workpiece, by means of the magnet unit, at sites at which access to an electricity supply network is unavailable or difficult, such that workpieces can be worked in a precise manner. Moreover, advantageously, it is possible to realize a power-tool stand device that is compact and, in particular, portable, and that is able to function independently of an electricity supply network. Thus, advantageously, a high degree of application convenience can be achieved.

Furthermore, it is proposed that the energy supply unit have at least one independent energy supply interface, on which an energy storage unit, in particular the energy storage unit of the energy supply unit, can be removably arranged, at least for the purpose of supplying energy to the magnet unit. Preferably, the independent energy supply interface has at least one guide element, in particular at least two guide elements, which guides/guide the energy storage unit during a movement for connecting to an electrical bearing-contact interface of the independent energy supply interface. The guide element/s is/are preferably of a design already known to persons skilled in the art, such as, for example, designed as a guide web or guide rib or the like. In addition, the independent energy supply interface comprises at least one securing element, for securing the energy storage unit to the independent energy supply interface. The securing unit is preferably of a design already known to persons skilled in the art, such as, for example, designed as a latching hook or the like. Preferably, the independent energy supply interface is realized in a manner similar to a receiving interface of a portable power tool that can be operated by a battery. It thus becomes possible, advantageously, to use energy storage units that are already available in a range of hand-held power tools, for the purpose of supplying energy to the power-tool stand device, in particular at least to the magnet unit. The design according to the disclosure makes it possible, through simple structural design, for the energy storage unit to be arranged in an exchangeable manner, to enable a discharged energy storage unit to be exchanged for a charged energy storage unit. Moreover, through simple structural design, it becomes possible for an energy storage unit to be arranged on the base body.

Further, it is proposed that the energy supply unit, in addition to supplying energy to the magnet unit, be provided, at least, to supply energy to a drive unit for the purpose of driving the insert tool. If the power-tool stand device is designed as a box column drill, the energy supply unit is preferably provided to supply energy to a drive unit of the box column drill. The drive unit in this case may be arranged in the base body of the power-tool stand device. If the power-tool stand device is designed as a drill stand, the energy supply unit is preferably provided to supply energy to a drive unit of a portable power tool that can be arranged in a detachable manner on the power-tool stand device, in particular on the base body. The design according to the disclosure thus enables the power-tool stand device to be used, particularly preferably, for precise working on workpieces at sites at which access to an electricity supply network is unavailable or difficult.

It is additionally proposed that the energy supply unit have at least one energy delivery interface, by means of which an external unit can be supplied with energy. An “external unit” is to be understood here to mean, in particular, a unit that, in particular, is realized such that it is separate from the power-tool stand device and, in particular, can be operated separately from the power-tool stand device in at least one state, such as, for example, an external suction extraction unit, an external portable power tool, an external test unit, an external lighting unit, an external loudspeaker unit, an external output unit, or the like. The energy delivery interface in this case may be of a cable-connected or wireless design. Moreover, it is conceivable for the energy supply unit to comprise a multiplicity of energy delivery interfaces, by means of which a plurality of external units can be supplied with energy, in which case the energy delivery interfaces may be realized as cable-connected and/or as wireless energy delivery interfaces. Preferably, the energy delivery interface is realized to correspond to a receiving interface of the external unit, on which, for example, at least one battery may be arranged. It thus becomes possible, advantageously, for the energy delivery interface to be arranged on the receiving interface of the external unit after a battery has been removed from the receiving interface of the external unit. It is also conceivable, however, for the energy delivery interface to be of another design, considered appropriate by persons skilled in the art, such as, for example, designed as an earthed socket, as a low-voltage plug-in connector, as a USB plug-in connector, or the like. The design according to the disclosure makes it possible, advantageously, to achieve a high degree of variability in respect of usability of the power-tool stand device. Moreover, advantageously, it becomes possible for energy to be supplied to an external unit at a site at which access to an electricity supply network is unavailable or difficult.

Furthermore, it is proposed that the magnet unit have at least one electromagnet. Preferably, at least one action of a magnetic field of the electromagnet can be switched on or off by means of a switching element of the magnet unit. Preferably, the magnet unit comprises a multiplicity of electromagnets, which are provided to fix the base body to a magnetizable object, in particular a workpiece. The design according to the disclosure makes it possible, advantageously, to realize a magnet unit that can be switched in a flexible and simple manner.

Further, it is proposed that the energy supply unit have at least one charging interface for charging an energy storage unit, in particular at least the energy storage unit of the energy supply unit. The charging interface may be of a cable-connected or wireless design. The charging interface may additionally be provided to charge an energy storage unit of the external unit. Further designs, considered appropriate by persons skilled in the art, are likewise conceivable. Preferably, the power-tool stand device preferably comprises an energy feed-in unit, which is provided to feed the energy storage unit, in particular to feed the energy storage unit via the charging interface. Preferably, the energy feed-in unit is realized as a solar unit. It is also conceivable, however, for the energy feed-in unit to be of another design, considered appropriate by persons skilled in the art, such as, for example, designed as a wind power unit or the like. The design according to the disclosure makes it possible, advantageously, to achieve a high degree of operating convenience, since it is possible, advantageously, to avoid removal of the energy storage unit for the purpose of charging by the independent energy supply interface. In addition, advantageously, it is possible to achieve an additional use for the power-tool stand device, in that a charging function can be realized.

It is additionally proposed that the charging interface be realized as an inductive charging interface. The charging interface preferably comprises at least one charging coil. The energy storage unit preferably comprises a receiver coil that is realized to correspond to the charging coil. The design according to the disclosure makes it possible, advantageously, to achieve a compact charging arrangement. Advantageously, therefore, the power-tool stand device can be of a compact design.

Furthermore, it is proposed that the power-tool stand device comprise at least one object bearing-contact unit, in particular workpiece bearing-contact unit, that can be arranged on the base body and on which the magnet unit can be arranged, at least partially, and which has at least one non-flat arrangement element, which is provided to enable the base body to be attached, in particular to enable the base body to be attached by means of the switchable magnet unit, to at least one object, in particular to at least one workpiece, having a non-flat, in particular round or polygonal, surface. Preferably, the non-flat arrangement element has at least one polygonal recess, in particular an at least partially prismatic recess. Preferably, the workpiece bearing-contact unit, in particular the non-flat arrangement element, can be removably arranged on the base body. The workpiece bearing-contact unit, in particular the non-flat arrangement element, can preferably be removably arranged on the base body by means of a fixing unit of the power-tool stand device. The fixing unit is preferably of a design already known to persons skilled in the art, such as, for example, a bayonet fixing unit, a latching-element fixing unit, a toggle-mechanism fixing unit, a positive-engagement plug-in fixing unit, or the like. It is also conceivable, however, for the non-flat arrangement element to be integral with the base body. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single or multi-component injection process and, advantageously, from a single blank. If the non-flat arrangement element is designed so as to be integral with the base body, the recess of the non-flat arrangement element is arranged on a side of the non-flat arrangement element that faces toward the object bearing-contact face, in particular the workpiece bearing-contact face. The design according to the disclosure makes it possible, advantageously, for the power-tool stand device, in particular the base body, to be arranged on non-flat objects, in particular workpieces, such as, for example, on tubes. It is thus possible, advantageously, to realize a wide spectrum of use for the power-tool stand device.

Additionally proposed is a power-tool system having at least one portable power tool, in particular having a battery-operated, portable power tool, and having at least one power-tool stand device according to the disclosure. A “portable power tool” is to be understood here to mean, in particular, a power tool for performing work on workpieces, that can be transported by an operator without the use of a transport machine. The portable power tool has, in particular, a mass of less than 40 kg, preferably less than 10 kg, and particularly preferably less than 5 kg. Preferably, the portable power tool is realized as a battery-operated power drill. It is also conceivable, however, for the portable power tool to be of a different design, considered appropriate by persons skilled in the art, such as, for example, designed as a percussion drill, as a router, or the like. The design according to the disclosure advantageously enables workpieces to be worked with precision at sites at which access to an electricity supply network is unavailable or difficult. Moreover, advantageously, it is possible to realize a power-tool system that is compact and, in particular portable, and that is able to function independently of an electricity supply network. Thus, advantageously, a high degree of application variability can be achieved.

It is additionally proposed that the energy supply unit have at least one energy storage unit, realized as a battery, which can be removably arranged on an independent energy supply interface of the energy supply unit of the power-tool stand device or on a receiving interface of the portable power tool. Preferably, the energy storage unit has a connecting interface, which is realized to correspond to the independent energy supply interface of the energy supply unit and to the receiving interface of the portable power tool. It is thus possible, advantageously, for the energy storage unit to be arranged on the receiving interface of the portable power tool when the energy storage unit is not used in combination with the energy supply unit. It is thus possible, advantageously, to realize a power-tool system in which, advantageously, the energy storage unit can be arranged according to a working application. Thus, advantageously, a high degree of application variability can be achieved.

The power-tool stand device according to the disclosure and/or the power-tool system according to the disclosure are/is not intended in this case to be limited to the application and embodiment described above. In particular, the power-tool stand device according to the disclosure and/or the power-tool system according to the disclosure may have individual elements, components and units that differ in number from a number stated herein, in order to fulfill a principle of function described herein. Moreover, in the case of the value ranges specified in this disclosure, values that are within the stated limits are to be deemed as disclosed and applicable in any manner.

### BRIEF DESCRIPTION OF THE DRAWINGS

Further advantages are disclosed by the following description of the drawing. The drawing shows two exemplary embodiments of the disclosure. The drawing, the description and the claims contain numerous features in combination. Persons skilled in the art will also expediently consider the features individually and combine them to create appropriate further combinations.

There are shown in:

FIG. 1 a power-tool system according to the disclosure, having at least one portable power tool, and having at least one power-tool stand device according to the disclosure, in a schematic representation,

FIG. 2 a detail view of an object bearing-contact unit of the power-tool stand device according to the disclosure, disposed on a base body of the power-tool stand device according to the disclosure, in a schematic representation,

FIG. 3 an alternative power-tool system according to the disclosure, having at least one alternative portable power tool, and having at least one alternative power-tool stand device according to the disclosure, in a schematic representation, and

FIG. 4 a further, alternative power-tool stand device according to the disclosure, in a schematic representation.

### DETAILED DESCRIPTION

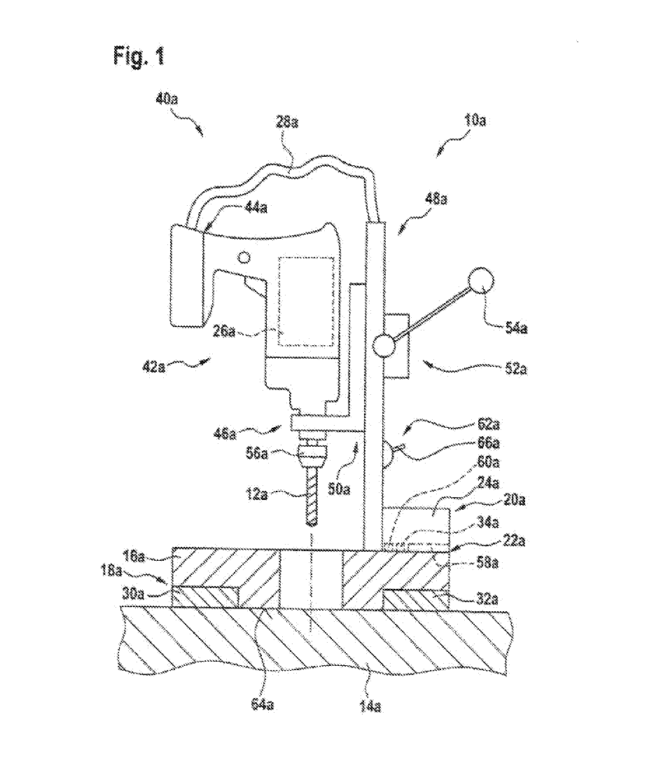

FIG. 1 shows a power-tool system 40a, having at least one portable power tool 42a, and having at least one power-tool stand device 10a. The portable power tool 42a is realized as a battery-operated, portable power tool 42a. The portable power tool 42a is realized as a drill. The portable power tool 42a is of a design that, at least substantially, is already known to persons skilled in the art. In addition, the portable power tool 42a can be arranged in a detachable manner on the drill stand device 10a. The power-tool stand device 10a comprises a clamping-in unit 46a, by means of which the portable power tool 42a can be fixed in a detachable manner to the power-tool stand device 10a. The clamping-in unit 46a is of a design already known to persons skilled in the art, such as, for example, designed as a clamping unit that is provided to bear against a collar of the portable power tool 42a by positive engagement and/or friction, in order to fix the portable power tool 42a on the power-tool stand device 10a. The clamping-in unit 46a is arranged in a movable manner on a linear guide unit 48a of the power-tool stand device 10a. The linear guide unit 48a is arranged in a stationary manner on the base body 16a of the power-tool stand device 10a. The clamping-in unit 46a can be fixed in a preliminary position, relative to the linear guide unit 48a, by means of a preliminary positioning unit 50a of the power-tool stand device 10a, in a manner already known to persons skilled in the art. The power-tool stand device 10a additionally comprises at least one plunge control unit 52a, which is provided to move the clamping-in unit 46a a limited distance, relative to the linear guide unit 48a, starting from a preliminary position, in a manner already known to persons skilled in the art. The portable power tool 42a, when having been disposed on the clamping-in unit 46a, can be moved relative to the base body 16a and relative to the linear guide unit 48a, in a manner already known to persons skilled in the art, for the purpose of performing work on a workpiece 14a. The plunge control unit 52a has at least one lever element 54a for moving the clamping-in unit 46a and, in particular, the portable power tool 42a. Advantageously, a high contact pressure of an insert tool 12a, disposed in a tool receiver 56a of the portable power tool 42a, can be generated for the purpose of performing work on the workpiece 14a, in particular in a manner already known to persons skilled in the art. The power-tool stand device 10a is realized as a drill stand device, on which the portable power tool 42a can be arranged in a detachable manner.

The power-tool stand device 10a, on which at least the insert tool 12a can be arranged in a drivable manner for the purpose of performing work on the workpiece 14a, in particular as a result of the insert tool 12a being arranged in the tool receiver 56a of the portable power tool 42a, which can be arranged on the power-tool stand device 10a, comprises at least the base body 16a, at least one switchable magnet unit 18a, at least for fixing the base body 16a to a magnetizable object, in particular to the workpiece 14a, and at least one energy supply unit 20a. The energy supply unit 20a is provided, at least to supply energy at least to the magnet unit 18a, independently of an electricity supply network. The energy supply unit 20a comprises at least one energy storage unit 24a, realized as a battery, which can be removably arranged on an independent energy supply interface 22a of the energy supply unit 20a of the power-tool stand device 10a. It is also conceivable, however, for the energy storage unit 24a, realized as a battery, to be integrated into the base body 16a, in particular integrated into the base body 16a at least in a substantially non-detachable manner. In addition, the energy storage unit 24a, realized as a battery, can be arranged on a receiving interface 44a of the portable power tool 42a, in particular when the energy storage unit 24a has been removed from the independent energy supply interface 22a. The energy storage unit 24a has a connecting interface (not represented in greater detail here), which is realized to correspond to the independent energy supply interface 22a of the energy supply unit 20a and to correspond to the receiving interface 44a of the portable power tool 42a.

The energy supply unit 20a comprises at least the independent energy supply interface 22a, on which the energy storage unit 24a can be removably arranged, at least for supplying energy to the magnet unit 18a. The independent energy supply interface 22a, for the purpose of removably arranging the energy storage unit 24a, has at least one guide element 58a (represented merely by a broken line here), which guides the energy storage unit 24a during a movement for connection to an electrical contact interface (not represented in greater detail here) of the independent energy supply interface 22a. Preferably, the independent energy supply interface 22a has at least two guide elements 58a, which are at least substantially similar in design. The guide elements 58a are preferably of a design already known to persons skilled in the art, such as, for example, designed as a guide web or guide rib, or the like. In addition, the independent energy supply interface 22a comprises at least one securing element 60a (represented merely by a broken line here), for securing the energy storage unit 24a to the independent energy supply interface 22a or to the base body 16a. The securing element 60a is preferably of a design already known to persons skilled in the art, such as, for example, designed as a latching hook or the like.

The switchable magnet unit 18a is arranged, at least partially, on the base body 16a, in particular in proximity to an object bearing-contact face 64a of the base body 16a. The magnet unit 18a is realized as an electromagnet unit. The magnet unit 18a comprises at least one electromagnet 30a. The electromagnet 30a is arranged on the base body 16a. The electromagnet 30a is arranged in proximity to the object bearing-contact face 64a of the base body 16a. Preferably, a face of the electromagnet 30a constitutes the object bearing-contact face 64a of the base body 16a, at least partially. The base body 16a is made, at least partially, of a magnetizable material such as, for example, iron or the like. An action of a magnetic field of the magnet unit 18a can be transmitted, advantageously, to the base body 16a, which itself is thus provided, advantageously, as a magnet holder. It is also conceivable, however, for the base body 16a to be made of a non-magnetizable material, and for the magnetic attachment of the base body 16a to the magnetizable object, in particular to the magnetizable workpiece 14a, to be achievable merely by means of the electromagnet 30a. Moreover, it is conceivable for the magnet unit 18a to comprise a multiplicity of electromagnets 30a, which are arranged with a uniform distribution or non-uniform distribution on the base body 16a. In the exemplary embodiment represented in FIG. 1, the magnet unit 18a has at least two electromagnets 30a, 32a. The electromagnets 30a, 32a are arranged with a uniform distribution on the base body 16a. The electromagnets 30a, 32a are arranged on two sides of the base body 16a that face away from each other. It is also conceivable, however, for the electromagnets 30a, 32a to be of another design, considered appropriate by persons skilled in the art, and/or to have another arrangement on the base body 16a, such as, for example, designed as ring electromagnets, the ring electromagnets being arranged concentrically with one another on the base body 16a, or the like.

The magnet unit 18a additionally comprises at least one switching unit 62a, by means of which an action of a magnetic field of the magnet unit 18a, in particular of the electromagnets 30a, 32a, can be switched on or off. The switching unit 62a comprises at least one switching element 66a. The switching element 66a is provided to interrupt or allow a supply of electrical energy to the electromagnets 30a, 32a from the energy storage unit 24a. It is also conceivable, however, for the switching unit 62a to be provided to set a magnetic field strength, as an alternative or in addition to switching an action of a magnetic field. Further designs of the switching unit 62a, considered appropriate by persons skilled in the art, are likewise conceivable.

Furthermore, the energy supply unit 20a, in addition to supplying energy to the magnet unit 18a, is provided, at least, to supply energy to a drive unit 26a, in particular to a drive unit 26a of the portable power tool 42a, for the purpose of driving the insert tool 12a. The drive unit 26a is part of the portable power tool 42a, which can be arranged in a detachable manner on the power-tool stand device 10a. The energy supply unit 20a has at least one energy delivery interface 28a, by means of which an external unit can be supplied with energy. In the exemplary embodiment represented in FIG. 1, the external unit is constituted by the portable power tool 42a, in particular by the drive unit 26a of the portable power tool 42a. In the exemplary embodiment represented in FIG. 1, the energy delivery interface 28a is cable-connected. It is also conceivable, however, for the energy delivery interface 28a to be of a wireless design, such as, for example, as an inductive energy delivery interface or the like. The energy delivery interface 28a, for the purpose of supplying energy to the portable power tool 42a, can be arranged on the receiving interface 44a of the portable power tool 42a, in particular when a battery unit has been removed from the receiving interface 44a of the portable power tool 42a. The energy delivery interface 26a is of a design that corresponds to the receiving interface 44a of the portable power tool 42a. It is also conceivable, however, for the energy delivery interface 28a to be of another design, considered appropriate by persons skilled in the art, and to be such that it can be electrically connected to the portable power tool 42a by means of, for example, a plug-and-socket connection that is other than the receiving interface 44a of the portable power tool 42a. Moreover, it is conceivable for the power-tool stand device 10a, alternatively or additionally, to have an energy delivery interface by means of which an external unit that is realized differently from the portable power tool 42a, such as for example, as a dust suction extraction device or the like, can be supplied with electrical energy.

Furthermore, the energy supply unit 20a comprises at least one charging interface 34a for charging the energy storage unit 24a. The charging interface 34a is realized as an inductive charging interface. The charging interface 34a may be of a cable-connected or wireless design. For the purpose of charging the energy storage unit 24a, the base body 16a can preferably be positioned in proximity to a charging coil (not represented in greater detail here), to enable, at least, electrical energy to be transmitted. Further designs of the charging interface 34a, considered appropriate by persons skilled in the art, are likewise conceivable, the energy supply unit 20a having, for example, a cable for connection to an electricity supply network, or a charging cable for charging additional or alternative energy storage units. Moreover, it is conceivable for the charging interface 34a to be used to charge further energy storage units (not represented in greater detail here), such as, for example, an energy storage unit (not represented in greater detail here) of the portable power tool 42a.

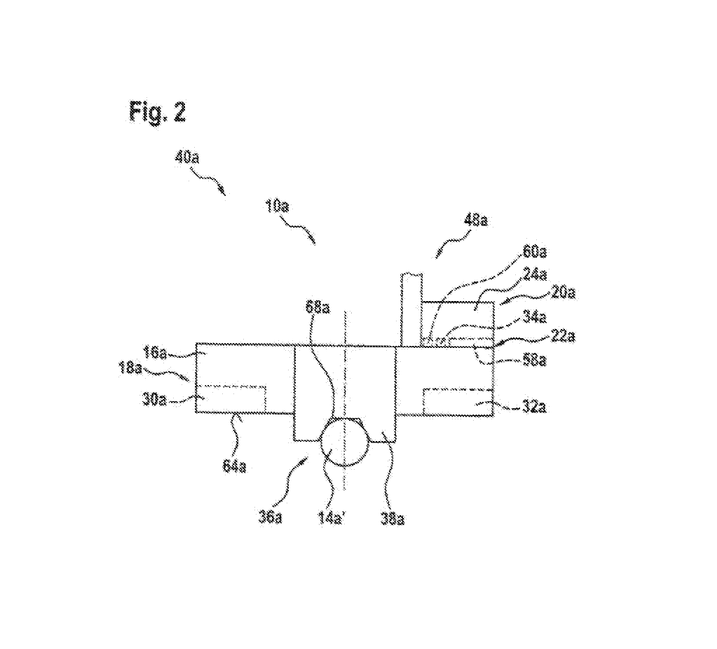

Furthermore, the power-tool stand device 10a comprises at least one object bearing-contact unit 36a that can be arranged on the base body 16a and on which the magnet unit 18a can be arranged, at least partially, and which has at least one non-flat arrangement element 38a, which is provided to enable the base body 16a to be attached to at least one magnetizable object, in particular to a magnetizable workpiece 14a′ having a non-flat surface (FIG. 2). The magnetizable workpiece 14a′ represented in FIG. 2 is realized as a tube. The object bearing-contact unit 36a, in particular the non-flat arrangement element 38a, can preferably be arranged in a removable manner on the base body 16a by means of a fixing unit (not represented in greater detail here) of the power-tool stand device 10a, in a manner already known to persons skilled in the art. The fixing unit is preferably of a design already known to persons skilled in the art, such as, for example, a bayonet fixing unit, a latching-element fixing unit, a toggle-mechanism fixing unit, a positive-engagement plug-in fixing unit, or the like. It is also conceivable, however, for the non-flat arrangement element 38a to be integral with the base body 16a, and thus to be integrated, in particular permanently, into the base body 16a (not represented in greater detail here). If the non-flat arrangement element 38a is integrated into the base body 16a, the non-flat arrangement element 38a is arranged in proximity to the electromagnets 30a, 32a. The non-flat arrangement element 38a has a polygonal recess 68a, in particular a prismatic recess 68a. Advantageously, the non-flat arrangement element 38a is made of a magnetizable material. Action of a magnetic force of the electromagnets 30a, 32a can thus cause the non-flat arrangement element 38a to be magnetized, to enable the power-tool stand device 10a to be attached to the magnetizable workpiece 14a′. It is also conceivable, however, for the magnet unit 18a to have at least one additional electromagnet (not represented in greater detail here), which is arranged in the non-flat arrangement element 38a. If the non-flat arrangement element 38a is of a detachable design, the additional electromagnet of the magnet unit 18a can preferably be electrically connected to the energy supply unit 20a as a result of the non-flat arrangement element 38a being arranged on the base body 16a, in particular in order to be realized so as to be switchable by means of the switching unit 62a. If the non-flat arrangement element 38a is arranged such that it is integrated into the base body 16a, the additional electromagnet is electrically connected to the energy supply unit 20a, in particular in order to be realized so as to be switchable by means of the switching unit 62a.

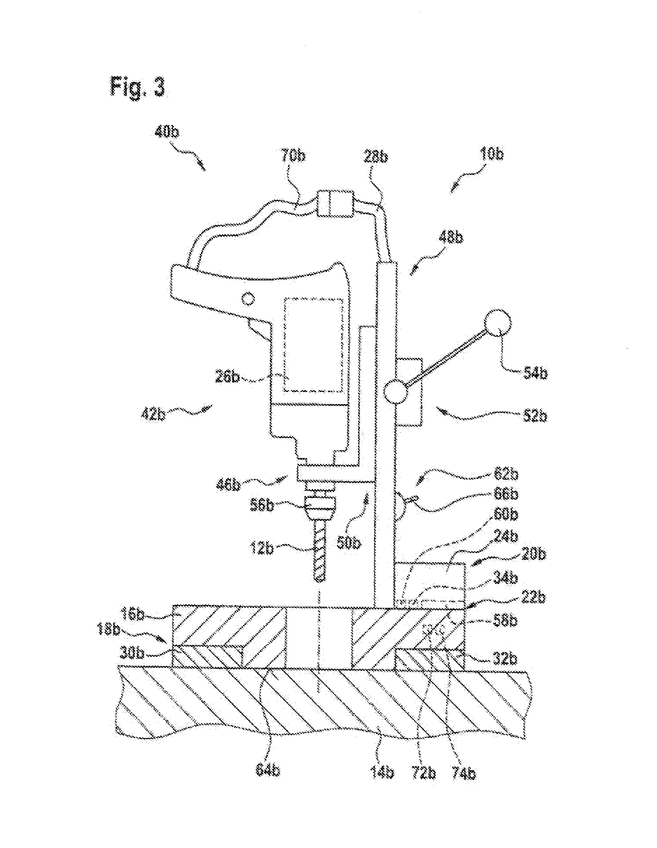

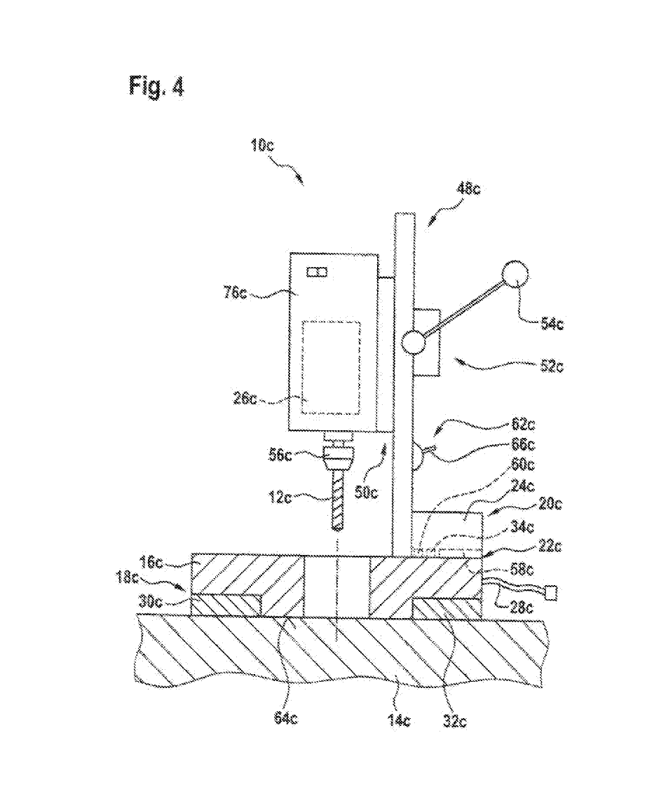

Further exemplary embodiments of the disclosure are shown in FIGS. 3 and 4. The following descriptions and the drawing are limited substantially to the differences between the exemplary embodiments, and in principle reference may also be made to the drawings and/or to the description of the other exemplary embodiments, in particular of FIGS. 1 and 2, in respect of components having the same designation, in particular relating to components having the same references. To distinguish the exemplary embodiments, the letter a has been appended to the references of the exemplary embodiment in FIGS. 1 and 2. In the exemplary embodiments of FIGS. 3 and 4, the letter a has been replaced by the letters b to c.

FIG. 3 shows an alternative power-tool system 40b, having at least one portable power tool 42b, and having at least one power-tool stand device 10b. Unlike the power-tool system 40a represented in FIGS. 1 and 2, the power-tool system 40b represented in FIG. 3 has a portable power tool 42b realized as a portable power tool that can be driven in a cable-connected manner. The power-tool stand device 10b represented in FIG. 3 is of a design that is at least substantially similar to that of the power-tool stand device 10a represented in FIGS. 1 and 2. The power-tool stand device 10b, on which at least one insert tool 12b can be arranged in a drivable manner for the purpose of performing work on a workpiece 14b, thus has at least one base body 16b, at least one switchable magnet unit 18b, at least for fixing the base body 16b to a magnetizable object, in particular to the magnetizable workpiece 14b, and at least one energy supply unit 20b. The energy supply unit 20b is provided, at least, to supply energy at least to the magnet unit 18a, independently of an electricity supply network.

Furthermore, the energy supply unit 20b, in addition to supplying energy to the magnet unit 18b, is provided, at least, to supply energy to a drive unit 26b, in particular to a drive unit 26b of the portable power tool 42b, for the purpose of driving the insert tool 12b. The energy supply unit 20b has at least one energy delivery interface 28b, by means of which an external unit can be supplied with energy. In the exemplary embodiment represented in FIG. 3, the external unit is constituted by the portable power tool 42b, in particular by the drive unit 26b of the portable power tool 42b. In the exemplary embodiment represented in FIG. 3, the energy delivery interface 28a is cable-connected. It is also conceivable, however, for the energy delivery interface 28b to be of another design, considered appropriate by persons skilled in the art. The energy delivery interface 28b, for the purpose of supplying energy to the portable power tool 42b, can be connected to an electric power supply cable 70b of the portable power tool 42b. The energy delivery interface 28b is of a design that corresponds to a plug-in connector region of the electric power supply cable 70b of the portable power tool 42b. The energy delivery interface 28b is realized as an earthed socket. It is also conceivable, however, for the energy delivery interface 28b to be of another design, considered appropriate by persons skilled in the art. The power-tool stand device 10b comprises at least one voltage transformer 72b, for transforming a voltage of an energy storage unit 24b of the energy supply unit 20b. The power-tool stand device 10b additionally comprises an inverter 74b, for generating an alternating current from a direct current of the energy storage unit 24b. In respect of further features and functions of the power-tool system represented in FIG. 3, reference may be made to the description of the power-tool system 40a represented in FIGS. 1 and 2.

FIG. 4 shows an alternative power-tool stand device 10c. The power-tool stand device 10c is realized as a box column drill. The power-tool stand device 10c, on which at least one insert tool 12c can be arranged in a drivable manner for the purpose of performing work on a workpiece 14c, comprises at least one base body 16c, at least one switchable magnet unit 18c, at least for fixing the base body 16c to a magnetizable object, in particular to the magnetizable workpiece 14c, and at least one energy supply unit 20c. The energy supply unit 20c is provided, at least, to supply energy to the magnet unit 18c, independently of an electricity supply network. The power-tool stand device 10c additionally comprises at least one housing unit 76c, which is provided, at least, to receive a drive unit 26c of the power-tool stand device 10c. It is conceivable in this case that, in addition to the drive unit 26c, at least one transmission unit of the power-tool stand device 10c is arranged in the housing unit 76c. Furthermore, the power-tool stand device 10c comprises at least one tool receiver 56c, on which the insert tool 12c can be arranged. The tool receiver 56c is rotatably mounted on the housing unit 76c. The housing unit 76c is mounted so as to be movable relative to the base body 16c, in particular independently of a clamping-in unit, in a manner already known to persons skilled in the art.

The energy supply unit 20c additionally has at least one independent energy supply interface 22c, on which an energy storage unit 24a of the energy supply unit 20c can be removably arranged, at least for the purpose of supplying energy to the magnet unit 18b. The energy supply unit 20c, in addition to supplying energy to the magnet unit 18b, be provided, at least, to supply energy to a drive unit 26c for the purpose of driving the insert tool 12c. The energy supply unit 20c has at least one energy delivery interface 28c, by means of which an external unit can be supplied with energy. The energy delivery interface 28c may be of a cable-connected and/or wireless design. The external unit may be realized as an external test unit, an external lighting unit, an external loudspeaker unit, as an external output unit, or the like. In respect of further features and functions of the power-tool stand device 10c represented in FIG. 4, reference may be made to the description of the power-tool stand device 10c represented in FIGS. 1 and 2.

What is claimed is:

1. A power-tool stand device configured to arrange at least one insert tool in a drivable manner for performing work on a workpiece, comprising:
at least one base body having at least one switchable magnet unit configured, at least, to fix the at least one base body to a magnetizable object; and
at least one energy supply unit configured, at least, to supply energy at least to the magnet unit independently of an electricity supply network.

2. The power-tool stand device according to claim 1, wherein the at least one energy supply unit has at least one independent energy supply interface, on which an energy storage unit is configured to be removably arranged, at least for supplying energy to the magnet unit.

3. The power-tool stand device according to claim 1, wherein the at least one energy supply unit, in addition to supplying energy to the magnet unit, is provided, at least, to supply energy to a drive unit for driving the insert tool.

4. The power-tool stand device according to claim 1, wherein the at least one energy supply unit has at least one energy delivery interface configured to supply an external unit with energy.

5. The power-tool stand device according to claim 1, wherein the magnet unit has at least one electromagnet.

6. The power-tool stand device according to claim 1, wherein the at least one energy supply unit has at least one charging interface configured to charge an energy storage unit.

7. The power-tool stand device according to claim 6, wherein the at least one charging interface includes an inductive charging interface.

8. The power-tool stand device according to claim 1, further comprising:
at least one object bearing-contact unit configured to be arranged on the at least one base body and on which the magnet unit is configured to be arranged, at least partially, and which has at least one non-flat arrangement element configured to enable the at least one base body to be attached to at least one object having a non-flat surface.

9. A power-tool system comprising:
at least one portable power tool; and
at least one power-tool stand device configured to arrange at least one insert tool in a drivable manner for performing work on a workpiece, the at least one power-tool stand device including (i) at least one base body having at least one switchable magnet unit configured, at least, to fix the at least one base body to a magnetizable object, and (ii) at least one energy supply unit configured, at least, to supply energy at least to the magnet unit independently of an electricity supply network.

10. The power-tool system according to claim 9, wherein the at least one energy supply unit has at least one energy storage unit, configured as a battery, which is removably arranged on an independent energy supply interface of the energy supply unit of the power-tool stand device or on a receiving interface of the portable power tool.
